(19) United States
(12) Patent Application Publication
(10) Pub. No.: US 2015/0085647 A1
(43) Pub. Date: Mar. 26, 2015

(54) Eliminating External Buffer for Hitless Protection by Using Channelized Flow Control

(71) Applicant: NEC Laboratories America, Inc., Princeton, NJ (US)

(72) Inventors: Junqiang Hu, Davis, CA (US); Yoshinobu Ooto, Tokyo (JP); Kazuo Takagi, Tokyo (JP); Yoshiaki Aono, Tokyo (JP); Ting Wang, West Windsor, NJ (US)

(21) Appl. No.: 14/325,242

(22) Filed: Jul. 7, 2014

Related U.S. Application Data
(60) Provisional application No. 61/864,738, filed on Aug. 12, 2013.

(51) Int. Cl. H04L 12/24; H04L 12/703; H04L 12/707

(52) U.S. Cl. CPC H04L 41/0668; H04L 45/22; H04L 45/28
USPC 370/228

(57) ABSTRACT

A packet switched communication system to support hitless protection includes a packet processor; a traffic manager with a buffer sized to compensate a maximum skew of each hitless path pair of a working path and a protecting path; and a hitless processor positioned between the packet processor and the traffic manager, wherein an interface between hitless processor and traffic manager has flow control to start or stop (XON/XOFF) traffic.

The present application claims priority to Provisional Application Ser. 61/864,738 filed Aug. 12, 13, the content of which is incorporated by reference.

### BACKGROUND

The present invention relates to hitless protection for packet switching systems.

In packet switching system, traffic manager (TM) is usually the main module to buffer packets and apply scheduling policy to provide specified services. Because of its common features and processing procedure, equipment vendors often use commercial TMs in system realization. Vendor specific features such as hitless protection may require a separate and customized device.

Hitless protection is the protection switching method to guarantee no traffic loss be hit when failure occurs. It is achieved through 1+1 network protection using source node replication plus destination node traffic selection. The two copies of traffic are sent from the same source node, pass through non-overlapped network paths (called working and protecting path respectively), and arrive the same destination node. For increased reliability, link aggregation group (LAG) is also used to connect the client to the core network, or connect two carrier networks, by using multiple links to avoid service interruption during single link failure. To simplify network management and operation, traffic sharing the same parameters (like priority and total bandwidth) and going to the same destination shall be aggregated into a single flow (for example, a single label switched path or LSP), regardless which physical port it is coming from. In more general case, multiple source flows from different LAGs can be aggregated into a single destination flow.

Due to the delay uncertainty of system switching and network forwarding, flow aggregation in network ingress node (NNI line card, outputting) and packets selection in network egress node (UNI line card, inputting) has to buffer the earlier packets. FIG. 1 gives the example of network ingress NNI buffering, where H1 and H2 are the input ports (i.e., UNI) of network ingress node; H3 and H4 are the output ports (i.e., NNI) of network ingress node. Such delay variation can be as much as 15 milliseconds (ms), which is around 1.5 Giga-bit (Gb) for a 100 Gb/s interface. This capacity is beyond the capability of on-chip buffers. If consider 2 Gbit/s access rate using state-of-the-art DDR3 memory, there will be at least 128 bit data width in parallel consider full-duplex operation and processing acceleration, which is equivalent to 8 DDR3-SDRAMs each of 16-bit data width. This is significant in terms of PCB space and number of I/O signals. The present invention is to avoid using external buffer for such hitless processing.

### SUMMARY

In one aspect, a packet switched communication system to support hitless protection includes a packet processor; a traffic manager with a buffer sized to compensate a maximum skew of each hitless path pair of a working path and a protecting path; and a hitless processor positioned between the packet processor and the traffic manager, wherein an interface between hitless processor and traffic manager has flow control to start or stop (XON/XOFF) traffic.

One embodiment uses channelized interface between traffic manager and hitless device. Hitless device uses per-channel flow control to enable or disable traffic receiving from traffic manager, in case the packets in buffer exceeds its threshold. Such flow control enables the additional packets to stay in TM buffers, to avoid the large buffer size in hitless device.

In network ingress node, the flow control happens in NNI, to compensate the switching skew. In such case each source flow (hitless only) is mapped to one channel. In network egress node, the flow control happens in UNI, to compensate the path skew (this can be the sum of network forwarding skew and system switching skew). In such case each hitless flow is mapped to two channels, for traffic from working and protecting path respectively. If traffic from working path always arrives earlier than that from protecting path, traffic from working paths may share one or more channel(s) with regular traffic, which means only hitless traffic from protecting path is allocated one channel for each. Regular flows are either mapped to a single channel, or to one channel for each output port, in both ingress node and egress node.

In another aspect, a method for communication includes aggregating packets from different ports in aligned mode; buffering a traffic manager to compensate a maximum switching skew among different ports for each flow; and providing as an interface between a hitless processor and a traffic manager with flow control to start or stop (XON/XOFF) traffic, wherein the interface between hitless processor and traffic manager is channelized interface, with per-channel XON/XOFF control and each source flow is mapped to one channel.

Advantages of the preferred embodiments may include one or more of the following. The present system provides a solution to reduce the required buffer size, to enable the realization of desired feature using embedded memory, which further reduces design complexity, PCB board space, system cost, and power consumption.

### BRIEF DESCRIPTION OF THE DRAWINGS

FIG. 1 shows an example of network ingress NNI buffering.

FIG. 2 shows a sample network for location of the target system and illustration of working/protecting paths.

FIG. 3 shows a VOQ, Interlaken logical channel, and physical interface mapping example.

FIG. 4 is an illustration of Interlaken XON/XOFF region.

FIG. 5 shows a dynamic buffer allocation and management for channelized Interlaken interface.

### DESCRIPTION

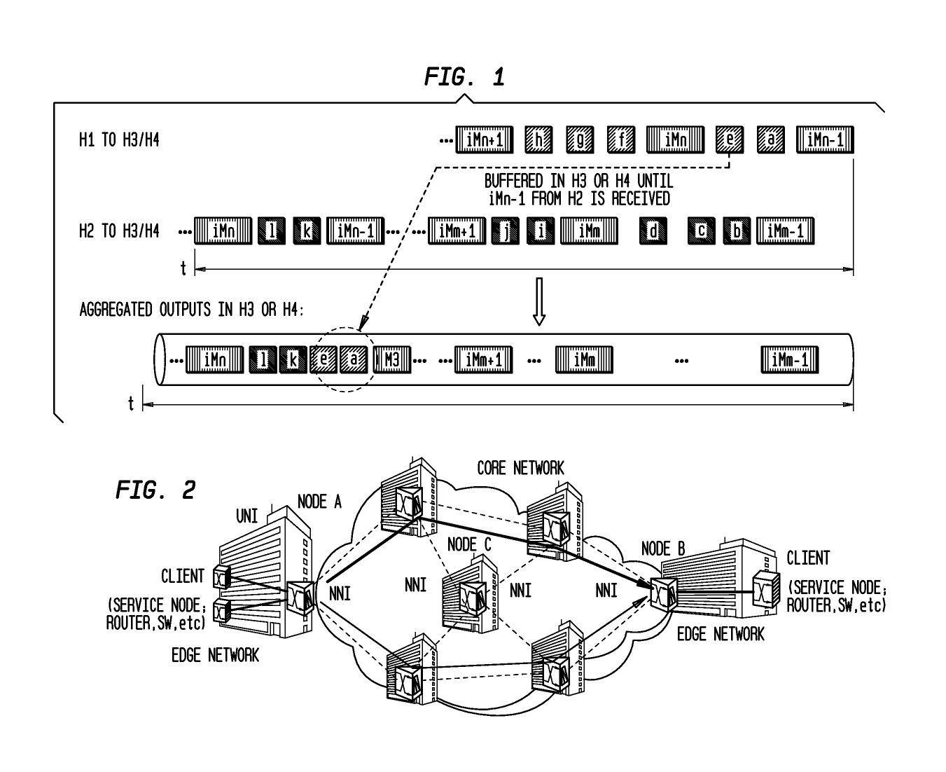

FIG. 2 shows exemplary deployed network infrastructure which includes access/edge networks and core networks. Systems are classified according to their connected networks. For example the system connecting the edge network and the core network, or that connects two different carrier networks, is called edge system; the system connecting other core nodes is called core system. For an edge node, the interface connecting the access or edge network is called user-network-interface (UNI), and the interface connecting to the core network is called network-network-interface (NNI). Network protection is usually provided from end to end (close to customer), or edge to edge. For either case, the network may have one working (primary) path plus a non-overlapped backup one for each traffic flow. These two paths are connected to different ports of a terminating node (e.g., the edge node when the protection is edge to edge).

FIG. 2 shows an example for traffic paths from edge node A to node B, where the green line represents the working path and red line for the backup one. There are two protecting modes commonly seen: one mode is that only one path contains traffic for the given flow; the other mode has duplicated traffic in both working and protecting paths. The former is called 1:1 (or 1:n if one path is used to protect multiple other paths) protection, and the latter is called 1+1 protection. Hitless protection uses 1+1 protection.

FIG. 2 shows an example network for location of the target system in this report (blue nodes) and illustration of working/protecting paths. Traffic aggregation in ingress NNI is detailed next. For increased reliability, link aggregation group (LAG) is commonly used to connect the client to the core network, or connect two carrier networks, by using multiple links to avoid service interruption during single link failure. LAG members are treated as a single logical port, so the traffic from these LAG members is usually aggregated before transmission. In more general case, the aggregation can be for any flows with the same policy such as priority and total bandwidth, going to the same destination. Such aggregation usually happens at NNI of network ingress node.

Next, the system architecture and skew compensation requirement for hitless processor are detailed. A common high capacity packet switching system consists of line card, switch fabric cards, and controller card. Each line card provides line interface, frame or packet processing, forwarding, and queue management, etc. Frame/packet processing and forwarding are usually executed in a network processor. Queue management module is also called traffic manager (TM), which buffers the packets in different queues and interacts with switch fabric for fabric scheduling. Switch fabric card contains switch fabric devices for packet switching from source to destination port, and provides centralized signal (like clock signal) when needed. Two fabric cards are used in the system for 1+1 or 1:1 redundancy, with each line card connected to both fabric cards. Control card contains the micro-processor as the main controller for the whole system, running software both to interface with other individual cards (including both line cards and switch fabric cards) for configuration/status monitoring and for network management.

Hitless related processing is located between network processor (or a similar functional module that provides classification feature) and traffic manager. In network ingress node, the UNI line cards groups the packets by inserting markers for each flow, and synchronizes with each other to enable aligned aggregation in NNI line card. The traffic is also replicated, either in hitless device, or in traffic manager, to reach destination ports connecting the working and protecting network paths. Based on markers from UNI, the network NNI aggregates the packets from different members of a LAG, or multiple LAGs, and sends to its connected network path (either working or protecting). Queuing and switching latency put skew for the groups from different UNIs, so the aggregation in NNI needs to compensate this skew to have the groups aligned before or during aggregation. Network egress node hitless processing receives a hitless flow from both working and protecting paths. Hitless service delivery requires it to actively monitor the status of the two paths, and compensate the lost packet(s) or switch to the other path. Such compensation or switching requires traffic from the two paths to be aligned; but because of network forwarding uncertainty and path difference, the received traffic from the two paths also has skew that needs to be compensated.

The present system uses channelized interface between hitless device and TM, with per-channel flow control to enable/disable the receiving from a particular flow. For network ingress node which requires compensation for skew from queuing and switching, each source hitless flow that is to be aggregated is mapped to one channel in NNI line card; all other traffic flows are either mapped to a single channel, or to one channel per destination port. For network egress node which requires compensation for path skew, each hitless flow is mapped to two channels, one for traffic from working path, and the other one for protecting path. Same as network ingress node, all other flows are either mapped to a single channel, or to one channel per output port.

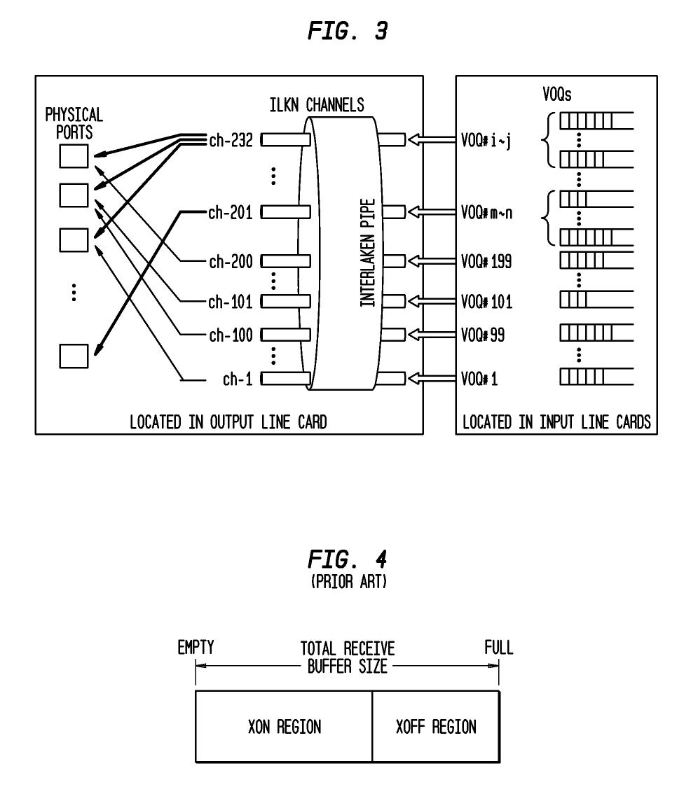

FIG. 3 shows an exemplary VOQ, Interlaken logical channel, and physical interface mapping example. Interlaken (ILKN) is used as example to explain the present operation. It provides flow control for each channel, for up to 256 channels in standard mode, or up to 64k channels in extended mode. In the example, consider using Interlaken in standard mode, to support 200 hitless flows (in terms of source line card) in one each hitless device (or one line card), and n outputting physical interfaces, where 200+n≦256, with an assumption that the scheduling for each Interlaken channel does not block any other channels in TM which is normally the case. The method is to allocate one dedicated channel for each hitless flow, and one dedicated channel for each physical interface for other traffic. Each Interlaken channel is further mapped to one (or more if consider multicasting) physical port. This mapping is configured in both TM and hitless device, as shown in FIG. 3. Each VOQ in this figure represents a flow. For hitless device output scheduling, which is the transmitting from Interlaken channels to physical ports, it may use simple round-robin algorithm, or strict priority (in which case there need to have n*n_pri channels for regular traffic, where n_pri is the number of priorities to support), or to follow packets arriving sequence by adding a timestamp (or using FIFO) to each received packet and transmit in first-come-first-serve manner.

Because of the latency from the triggering of XON/XOFF message (for example, buffer reaches pre-defined threshold) to the peer side taking action (to start sending or stopping packets for that channel), the receiver buffer size shall be at least the sum of XON and XOFF region (see FIG. 4). Whenever the buffer reaches (or is in) XON region, it sends XON message to the transmitter, to enable packets delivery; when the buffer reaches (or is in) XOFF region, it sends XOFF message, notifying the transmitter to stop sending packets for that channel.

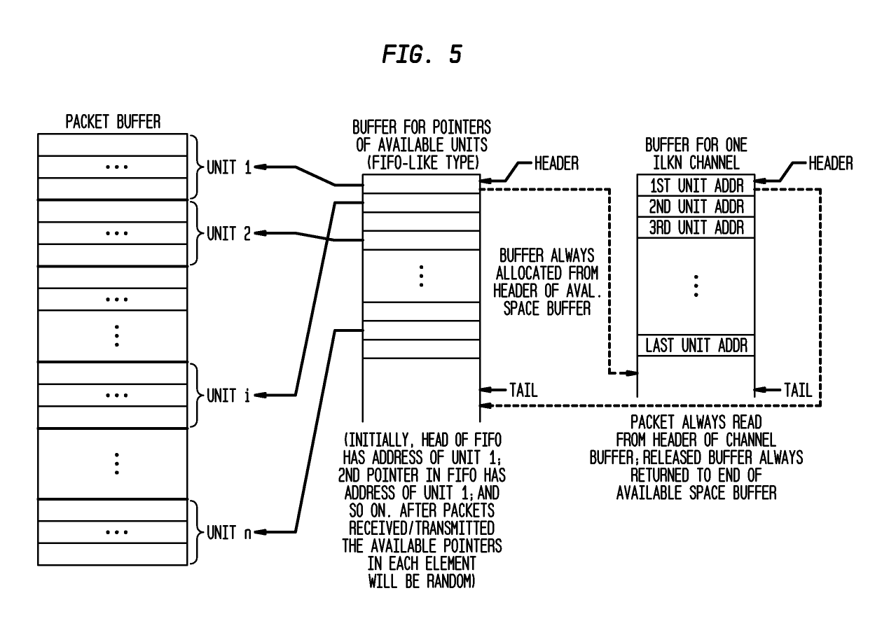

FIG. 4 illustrates the operation of Interlaken XON/XOFF region, while FIG. 5 shows a dynamic buffer allocation and management for channelized Interlaken interface. The XON and XOFF region for each hitless flow is calculated from the allocated bandwidth, allowed burst length, and XON/XOFF reaction time (i.e., the flow control latency tL as given in Interlaken protocol, which is the sum of Status Change Latency tSCL, Status Transmit Latency tSTL, Transmitter Control Latency tTCL, and Transmitter Pipeline Latency tTPL), from max(BW*XON_or_XOFF_reaction_time, burst_len). If the skew compensation is for a packet group and it can only be known after the receiving for the whole group is finished, the XON region shall add the maximum group size.

Because of the dynamic nature of flow creations, if using fixed buffer allocation, the buffer size (i.e., XON+XOFF region) for each flow shall be the maximum of the all the possible configurations. However, this may require larger buffer size than available in a state-of-the-art device, or increase ASIC cost. Dynamic buffer management is necessary to enable buffer sharing among all the active flows. FIG. 5 is the illustration to dynamically allocate and manage the hitless device internal buffers. It organizes all the available memory resources as a single buffer pool. This buffer pool is divided into unit of (fixed size) cells (for example, 64 bytes); each packet can be stored in one or more units. The buffer management module handles the available buffers, which are initialized with all the available units. Packet buffer is allocated upon packet arrival and released (returned back to buffer management module) when it is transmitted. Each flow organizes its own allocated buffers, using pointer buffer, which can have fixed address/size or organized by its stored pointer. If fixed pointer buffer is used, the buffer size shall be allocated to accommodate the maximum number of packets. In any case, XON and XOFF region is calculated based on the bandwidth and burst size of each flow as mentioned above.

The packet switched communication system supports hitless protection with a hitless protection processing hardware (or called hitless processor) is located between packet processor and traffic manager. The traffic manager has buffer with size enough to compensate the maximum skew of each hitless path pair (i.e., the skew between working path and protecting path); the interface between hitless processor and traffic manager has flow control to start or stop (XON/XOFF) traffic.

The interface between hitless processor and traffic manager is channelized interface, with per-channel XON/XOFF control. Each flow of hitless traffic is mapped to two channels: one channel for the flow from working path and another one from protecting path. Each flow from protecting path is mapped to one channel; flows from working path share one or more channels, given that traffic from working path is always earlier than from the protecting path. Per-channel Xon/Xoff is applied to hitless traffic. Each channel has its XON/XOFF region; when the buffer in use reaches Xon region, it sends XON command or stays in XON state; when reaches XOFF region, it sends XOFF command or stays in XOFF state. The XON region is calculated by maximum number of transmitting bytes during maximum XOFF reaction time, while the XOFF region is calculated by maximum number of receiving bytes during maximum XOFF reaction time. A dynamic buffer allocation is applied to each channel. Available buffers are organized in fixed units, each containing fixed number of bytes. A buffer pool stores the pointers for all the available units, and a buffer pool is organized in FIFO mode. The buffer pool has all unit buffers available during initialization; it removes one unit as it is allocated, and returns (adds) one unit as it is released. Each channel has a buffer, for the pointers of its allocated units. This buffer has related parameter of XON and XOFF region. This buffer has pre-allocated size able to buffer the channel of maximum XON/XOFF region channels. Once a unit is allocated, it is written into the tail of this buffer; once it is released, it is removed from the header of this buffer and returned into buffer pool. Regular traffic uses one channel per output port; or the number channels per output port equals to the number priorities. Hitless flows are organized in group, the Xoff region is maximum group size (in bytes) plus the maximum number of transmitting bytes during maximum XOFF reaction time. Each group is identified by marker packet, and the interface is Interlaken.

In another implementation, a method for a packet switched communication system supports traffic aggregation. In this system, the traffic aggregator aggregates the packets from different ports in aligned mode; and the traffic manager has buffer to compensate the maximum switching skew among different port for each flow; the interface between hitless processor and traffic manager has flow control to start or stop (XON/XOFF) traffic. The interface between hitless processor and traffic manager is channelized interface, with per-channel XON/XOFF control. Each source flow is mapped to one channel.

In implementations, per-channel Xon/Xoff is applied to the traffic to be aggregated in aligned mode. Each channel has its XON/XOFF region; when the buffer used reaches Xon region, it sends XON command or stays in XON state; when reaches XOFF region, it sends XOFF command or stays in XOFF state. The XON region is calculated by maximum number of transmitting bytes in aggregator during maximum XOFF reaction time. The XOFF region is calculated by maximum number of receiving bytes in aggregator during maximum XOFF reaction time. Dynamic buffer allocation is applied to each channel. Traffic without aligned aggregation requirement is mapped to one channel per output port. All traffic without aligned aggregation requirement is mapped to a single channel. Hitless flows are organized in group, the Xoff region is maximum group size (in bytes) plus the maximum number of transmitting bytes during maximum XOFF reaction time. Each group is identified by marker packet. The interface is Interlaken. he flows with aligned aggregation requirement are hitless flows, from different members of the same LAG, or from different LAGs.

The system uses channelized interface between hitless device and traffic manager. Each deskew related channel has a pre-calculated XON/XOFF region. When a channel reaches the threshold of XON region from XOFF region, it sends XON message to enable packet receiving from that channel; when a channel reaches the threshold of XOFF region from XON region, it sends XOFF message to disable packet receiving from that channel. The method enables deskew buffering in traffic manager queue, so that the buffer size for each channel is only its XON+XOFF region. Other advantages of the system may include one or more of the following:
The system uses channelized flow control to push de-skew buffering into traffic manager
Each hitless (source) flow is mapped into one channel in network ingress NNI, and all other flows are mapped to one other channel, or one channel per output port
Each hitless flow that will be aggregated (in group aligned mode) is mapped into two channels in network egress NNI, one for traffic from working path and the second one for traffic from protecting path; all other flows are mapped to one channel, or one channel per output port
The system provides dynamic buffer management inside hitless processor; each flow has one buffer for pointer, with this buffer able to store the pointers for XON+XOFF region

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A packet switched communication system, to support hitless protection, comprising
a packet processor;
a traffic manager with a buffer sized to compensate a maximum skew of each hitless path pair of a working path and a protecting path;
a hitless processor positioned between the packet processor and the traffic manager, wherein an interface between hitless processor and traffic manager has flow control to start or stop (XON/XOFF) traffic.

2. The system of claim 1, wherein the interface between hitless processor and traffic manager is a channelized interface with per-channel XON/XOFF control.

3. The system of claim 1, wherein each flow of hitless traffic is mapped to two channels: one channel for the flow from the working path and another one from the protecting path.

4. The system of claim 1, wherein each flow from protecting path is mapped to one channel and flows from the working path share one or more channels.

5. The system of claim 1, wherein each channel has an XON/XOFF region and when a buffer in use reaches the XON region, the buffer sends an XON command or stays in the XON state, and when the buffer reaches XOFF region, the buffer sends the XOFF command or stays in the XOFF state.

6. The system of claim 1, wherein an XON region is calculated by a maximum number of transmitting bytes during a maximum XOFF reaction time.

7. The system of claim 1, wherein an XOFF region is calculated by maximum number of receiving bytes during maximum XOFF reaction time

8. The system of claim 1, wherein dynamic buffer allocation is applied to each channel

9. The system of claim 1, wherein available buffers are organized in fixed units, each containing fixed number of bytes.

10. The system of claim 1, wherein a buffer pool stores pointers for available units with pre-allocated size to buffer the channel with maximum XON/XOFF region channels.

11. The system of claim 1, wherein traffic uses one channel per output port where a number channels per output port equals to the number priorities.

12. The system of claim 1, wherein hitless flows are organized in group, the Xoff region is maximum group size (in bytes) plus the maximum number of transmitting bytes during maximum XOFF reaction time.

13. The system of claim 1, wherein each group is identified by marker packet

14. The system of claim 1, wherein the interface is Interlaken.

15. The system of claim 1, wherein per-channel Xon/Xoff is applied to traffic to be aggregated in aligned mode.

16. The system of claim 1, wherein an XOFF region is calculated by a maximum number of receiving bytes in aggregator during maximum XOFF reaction time.

17. The system of claim 1, wherein each group is identified by marker packet.

18. The system of claim 1, wherein flows with an aligned aggregation requirement are hitless flows, from different members of the same LAG, or from different LAGs.

19. A method for communication, comprising:
aggregating packets from different ports in aligned mode;
buffering a traffic manager to compensate a maximum switching skew among different ports for each flow; and
providing as an interface between a hitless processor and a traffic manager with flow control to start or stop (XON/XOFF) traffic, wherein the interface between hitless processor and traffic manager is channelized interface, with per-channel XON/XOFF control and each source flow is mapped to one channel.

20. The method of claim 19, comprising applying per-channel Xon/Xoff to traffic to be aggregated in aligned mode, wherein each channel has its XON/XOFF region, wherein when the buffer reaches Xon region or XOFF regions, comprising sending XON or XOFF command or staying in XON state.
